(19) United States
(12) Patent Application Publication
(10) Pub. No.: US 2013/0134901 A1
(43) Pub. Date: May 30, 2013

(54) DRIVING APPARATUS FOR LIGHT EMITTING DIODE AND CONTROL METHOD THEREOF

(71) Applicants: Chan Woo PARK, Seoul (KR); Sang Hyun CHA, Seoul (KR); Se Hoon YOO, Seoul (KR); Jong Woo LEE, Seoul (KR); Ki Chul KIM, Seoul (KR); Jung Chul GONG, Seoul (KR); Jae Shin LEE, Seoul (KR)

(72) Inventors: Chan Woo PARK, Seoul (KR); Sang Hyun CHA, Seoul (KR); Se Hoon YOO, Seoul (KR); Jong Woo LEE, Seoul (KR); Ki Chul KIM, Seoul (KR); Jung Chul GONG, Seoul (KR); Jae Shin LEE, Seoul (KR)

(73) Assignee: SAMSUNG ELECTRO-MECHANICS CO., LTD./University of Seoul Industry Cooperation Foundation

(21) Appl. No.: 13/451,297

(22) Filed: Apr. 19, 2012

(30) Foreign Application Priority Data
Nov. 28, 2011 (KR) 10-2011-0125074

(51) Int. Cl. H05B 37/02

(52) U.S. Cl. 315/294

(57) ABSTRACT

There are provided a driving apparatus for a light emitting diode (LED) which may accurately display a desired color of light by adjusting a color coordinate value in accordance with an input brightness value, and a control method thereof. The driving apparatus includes a control unit receiving a brightness value and a color coordinate value of an LED desired to be controlled and controlling LED driving by adjusting the color coordinate value in accordance with the received brightness value; and a driving unit driving the LED in accordance with controlling of the control unit.

### CROSS-REFERENCE TO RELATED APPLICATIONS

This application claims the priority of Korean Patent Application No. 10-2011-0125074 filed on Nov. 28, 2011, in the Korean Intellectual Property Office, the disclosure of which is incorporated herein by reference.

### BACKGROUND OF THE INVENTION

1. Field of the Invention

The present invention relates to a driving apparatus for a light emitting diode (LED) that may control color illumination in accordance with an input color coordinate value and an input brightness value, and a control method thereof.

2. Description of the Related Art

In recent years, interest in and demand for light emitting diode (LED) lighting apparatuses have increased.

Due to the fact that an LED lighting apparatus can be manufactured to have a compact size, an LED lighting apparatus may be used even in a place in which it is difficult to install an existing lighting apparatus. In addition, the implementation of various colors and adjustment of the intensity of illumination may be facilitated in LED lighting, such that LED lighting may be used in lighting systems suitable for various situations such as projecting movies, reading, meetings, and the like.

In addition, the power consumption of LED lighting is approximately ⅛ that of an incandescent bulb, and a lifespan thereof is 50,000 to 100,000 hours, 5 to 10 times that of the incandescent bulb. In addition, the LED lighting is an environmentally-friendly mercury-free light source, and various designs are available.

Due to these characteristics, LED lighting initiatives have been undertaken as national research projects in many countries, such as the United States, Japan, and Australia, as well as in Korea.

Meanwhile, related art lighting has only ever been used for the purpose of simply emitting light, or providing information. However, with improvements in the quality of life, driving apparatuses having more complex and varied functions have been developed for the purpose of user conveniences, consumer demand, and the like. LEDs have significantly high color reproducibility, and are able to adjust color temperature and brightness levels in detail, such that a lighting control system using the LED may satisfy user convenience and consumer demand.

A driving system for the LED may be configured as shown in FIG. 1.

That is, referring to FIG. 1, in a general driving system for an LED, a control server and a control panel are connected in a TCP/IP scheme to perform on/off lighting control, dimming control, and power use monitoring, and an LED driver and a remote controller for controlling the LED driver are connected to a lighting communications protocol.

In the above described general driving system for an LED, the CIE 1931 chromaticity diagram may be commonly used for color control, and a three-color LED including red, green, and blue LEDs may be used to display a variety of colors. When using the three-color LED, a brightness ratio of individual LEDs within the three-color LED is appropriately controlled, so that a variety of colors may be displayed therewith.

However, LED color coordinates may be altered due to a current, a temperature, and the like, so that a desired color of light may be slightly changed in accordance with lighting brightness.

In order to solve these problems, a feedback system or a sensing circuit is added in the related art; however, this may cause other problems in terms of an increased circuit area and increased manufacturing costs.

### SUMMARY OF THE INVENTION

An aspect of the present invention provides a driving apparatus for a light emitting diode (LED) which may accurately emit light of a desired color by adjusting an input color coordinate value in accordance with an input brightness value, and a control method thereof.

According to an aspect of the present invention, there is provided a driving apparatus for an LED (Light Emitting Diode), including: a control unit controlling LED driving by adjusting a color coordinate value in accordance with a brightness value of an LED desired to be controlled; and a driving unit driving the LED in accordance with controlling of the control unit.

The driving unit may include a first driving unit driving a red LED in accordance with the controlling of the control unit, a second driving unit driving a green LED in accordance with the controlling of the control unit, and a third driving unit driving a blue LED in accordance with the controlling of the control unit.

The control unit may include a lookup table having color coordinate values set in accordance with the brightness value to thereby adjust the color coordinate value in accordance therewith.

The lookup table may include an x-color coordinate value and a y-color coordinate value of the red LED, an x-color coordinate value and a y-color coordinate value of the green LED, and an x-color coordinate value and a y-color coordinate value of the blue LED.

When the brightness value is equal to or greater than a preset reference brightness value, the x-color coordinate value of the red LED may be increased, and the y-color coordinate value of the red LED may be decreased.

When the brightness value is equal to or greater than a preset reference brightness value, the x-color coordinate value of the green LED may be decreased, and the y-color coordinate value of the green LED may be increased.

When the brightness value is equal to or greater than a preset reference brightness value, the x-color coordinate value of the blue LED may be increased, and the y-color coordinate value of the blue LED may be decreased.

According to another aspect of the present invention, there is provided a control method of a driving apparatus for an LED, the control method including: receiving a brightness value and a color coordinate value of an LED desired to be controlled to thereby determine a brightness value of each of a red LED, a green LED, and a blue LED; selecting, from a preset lookup table, an x-color coordinate value and a y-color coordinate value of each of the red LED, the green LED, and the blue LED in accordance with the brightness value of each of the red LED, the green LED, and the blue LED; and determining a brightness value ratio of each of the red LED, the green LED, and the blue LED in accordance with the selected x-color coordinate value and y-color coordinate value of each of the red LED, the green LED, and the blue LED and the received brightness value.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic diagram illustrating the configuration of a general driving system for a light emitting diode (LED);

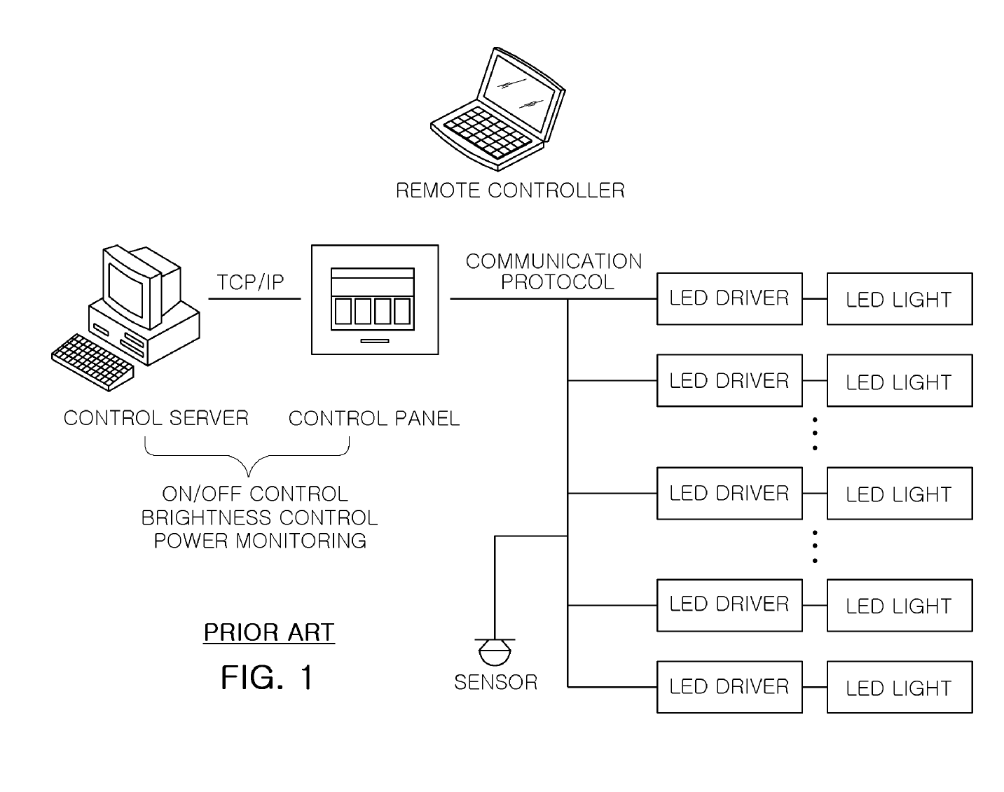

FIG. 2 is a graph illustrating a state in which color coordinates are moved in accordance with a current;

FIG. 3 is a schematic diagram illustrating the configuration of a driving apparatus for an LED according to an embodiment of the present invention;

FIG. 4 is an example of a lookup table used in a driving apparatus for an LED according to an embodiment of the present invention; and

FIG. 5 is a flowchart illustrating a control method of a driving apparatus for an LED according to an embodiment of the present invention.

### DETAILED DESCRIPTION OF THE INVENTION

Hereinafter, embodiments will be described in detail with reference to the accompanying drawings so that they can be easily practiced by those skilled in the art to which the present invention pertains.

However, in describing embodiments of the present invention, detailed descriptions of well-known functions or constructions will be omitted so as not to obscure the description of the present invention with unnecessary detail.

In addition, like reference numerals denote parts performing similar functions and actions throughout the drawings.

In addition, in a whole disclosure, when one element is referred to as being “connected” to another element, it should be understood that the former can be “directly connected” to the latter, or “indirectly connected” to the latter via an intervening element.

Unless explicitly described to the contrary, the word “comprise” and variations such as “comprises” or “comprising,” will be understood to imply the inclusion of stated elements but not the exclusion of any other elements.

Embodiments of the present invention will now be described in detail with reference to the accompanying drawings.

A color coordinate system of color control that is used to control colors of a light emitting diode (LED) is referred to as the CIE 1931 XYZ coordinate system as an XYZ coordinate system. Here, X, Y, and Z are tristimulus values, and have similar characteristics as those of a light recognition algorithm of a human being in which red, green, and blue colors are respectively recognized as basic values that quantitatively display colors. The X, Y, and Z coordinates may match x, y, and Y values of the CIE 1931 chromaticity diagram through the following Equation 1:

$${x}_{i} = \frac{{X}_{i}}{{X}_{i} + {Y}_{i} + {Z}_{i}} {y}_{i} = \frac{{Y}_{i}}{{X}_{i} + {Y}_{i} + {Z}_{i}} {z}_{i} = \frac{{Z}_{i}}{{X}_{i} + {Y}_{i} + {Z}_{i}} \qquad Equation 1$$

Here, xi, yi, and zi denote chromaticity values.

When using xi+yi+zi=1 in Equation 1, the following Equation 2 is obtained.

$${X}_{i} = \frac{{x}_{i}}{{y}_{i}} {Y}_{i} \\ {Y}_{i} = {Y}_{i} \\ {Z}_{i} = \frac{1 - {x}_{i} - {y}_{i}}{{y}_{i}} {Y}_{i} \qquad Equation 2$$

In Equation 2, an almost accurate color mixing formula may be obtained using four arithmetic operations when mixing colors, as a formula for a color mixing process.

When it is assumed that the number of light sources is n, the following Equation 3 may be obtained in a case of mixing n light sources.

$${X}_{mixed} = {\sum }_{i = 1}^{n} {X}_{i} \\ {Y}_{mixed} = {\sum }_{i = 1}^{n} {Y}_{i} \\ {Z}_{mixed} = {\sum }_{i = 1}^{n} {Z}_{i} \qquad Equation 3$$

When the results of Equation 3 may be converted into x, y, and Y values of the CIE 1931 chromaticity diagram using Equation 2, and the following Equation 4 may show the converted results.

$$[ \begin{matrix}{X}_{mixed} \\ {Y}_{mixed} \\ {Z}_{mixed}\end{matrix} ] = [ \begin{matrix}\frac{{x}_{1}}{{y}_{1}} & \frac{{x}_{2}}{{y}_{2}} & \frac{{x}_{3}}{{y}_{3}} & & \frac{{x}_{n}}{{y}_{n}} \\ 1 & 1 & 1 & … & 1 \\ \frac{1 - {x}_{1} - {y}_{1}}{{y}_{1}} & \frac{1 - {x}_{2} - {y}_{2}}{{y}_{2}} & \frac{1 - {x}_{3} - {y}_{3}}{{y}_{3}} & & \frac{1 - {x}_{n} - {y}_{n}}{{y}_{n}}\end{matrix} ] [ \begin{matrix}{Y}_{1} \\ {Y}_{2} \\ {Y}_{3} \\ ⋮ \\ {Y}_{n}\end{matrix} ] \qquad Equation 4$$

When, using the results of Equation 4, a Ymixed luminance is set to 1 lm, and Y1, Y2, and Y3 are respectively set to a mixing ratio of a red LED, a green LED, and a blue LED to 1 lm, the following Equation 5 may be obtained.

$$Equation 5 \\ [ \begin{matrix}{Im}_{R} \\ {Im}_{B} \\ {Im}_{G}\end{matrix} ] = [ \begin{matrix}\frac{{X}_{R}}{{Y}_{R}} & \frac{{X}_{G}}{{Y}_{G}} & \frac{{X}_{B}}{{Y}_{B}} \\ 1 & 1 & 1 \\ \frac{1 - {X}_{R} - {Y}_{R}}{{Y}_{R}} & \frac{1 - {X}_{G} - {Y}_{G}}{{Y}_{G}} & \frac{1 - {X}_{B} - {Y}_{B}}{{Y}_{B}}\end{matrix} ] {}^{- 1} [ \begin{matrix}\frac{{X}_{out}}{{Y}_{out}} \\ 1 \\ \frac{1 - {X}_{out} - {Y}_{out}}{{Y}_{out}}\end{matrix} ]$$

In Equation 5, xout and yout denote desired output coordinate values, xR, yR, xG, yG, xB, and yB respectively denote an x-color coordinate value and a y-color coordinate value of the red LED, an x-color coordinate value and a y-color coordinate value of the green LED, and an x-color coordinate value and a y-color coordinate value of the blue LED, and lmR, lmG, and lmB respectively denote a mixing ratio of the red LED, the green LED, and the blue LED to a lighting output of 1 lm.

Equation 5 is a formula used for determining the mixing ratio of the red LED, the green LED, and the blue LED to obtain the desired output coordinates xout and yout. Here, lmR+lmG+lmB=1 lm is satisfied. In order for the conversion into a desired output brightness of lm, it may be determined by multiplying lmR, lmG, and lmB obtained through Equation 5 by a desired output value.

For example, when a value of each of lmR, lmG, and lmB used for obtaining the desired output coordinates is 0.3, 0.4, and 0.3, and a value of the output lm is 500 lm, 150 lm, 200 lm, and 150 lm may be respectively determined in the mixing ratio of the red LED, the green LED, and the blue LED by multiplying 0.3, 0.4, and 0.3 by 500.

By adjusting a duty cycle for driving the LED based on the determined lm value, a lighting having a desired brightness and color may be implemented.

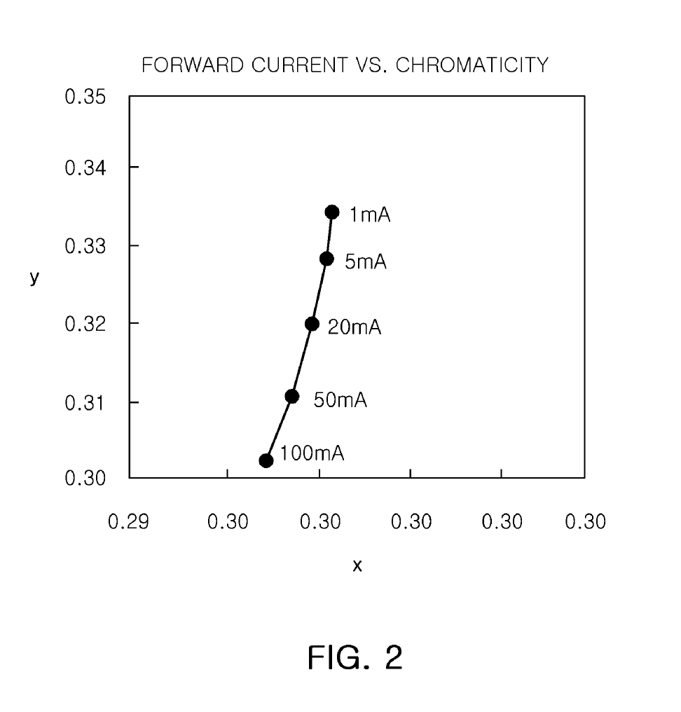

However, when a duty cycle of a driving signal is changed to adjust brightness control, a change in a current flowing in the LED is caused, so that it is difficult to accurately control a color desired to be obtained by changing characteristics of the LED as shown in FIG. 2.

FIG. 2 is a graph illustrating a state in which color coordinates are moved in accordance with a current.

Referring to FIG. 2, it may be seen that an x-color coordinate value and a y-color coordinate value are moved in accordance with an amount of current flowing in the LED as described above. Thus, it is difficult to accurately control a color of the LED desired to be controlled.

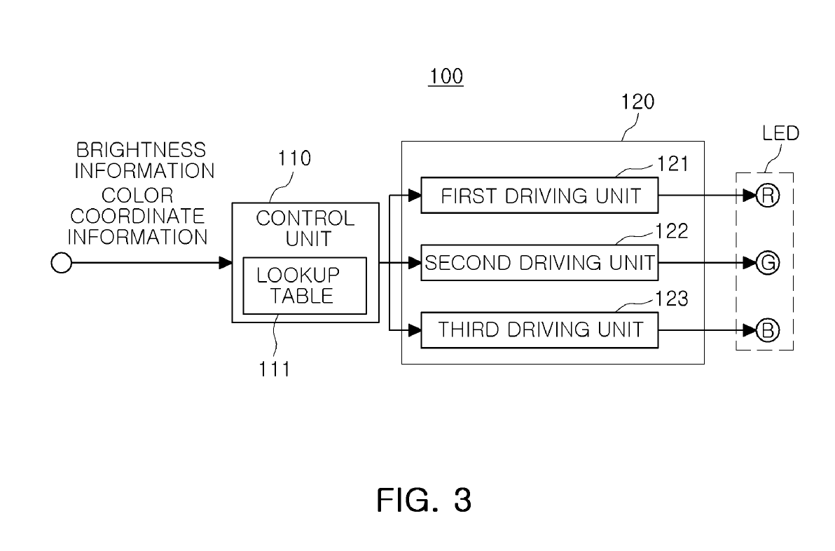

FIG. 3 is a schematic diagram illustrating the configuration of a driving apparatus for an LED according to an embodiment of the present invention.

Referring to FIG. 3, a driving apparatus 100 for an LED may include a control unit 110 and a driving unit 120.

The control unit 110 may provide a PWM signal capable of driving the LED to the driving unit 120 in accordance with brightness information input from the outside, and a brightness value and a color coordinate value included in color coordinate information.

In order to control colors of the LED as described above, the control unit 110 may obtain color coordinate values as shown in Equation 5, using the CIE 1931 xyz coordinate system.

That is, xR, yR, xG, yG, xB, and yB which are color coordinate values of the red LED, the green LED, and the blue LED may be obtained, such that the PWM signal that drives each of first to third driving units 121, 122, and 123 of the driving unit 120 may be provided, and a duty cycle of the PWM signal may be varied in accordance with xR, yR, xG, yG, xB, and yB, the color coordinate values of the red LED, the green LED, and the blue LED.

The first to third driving units 121, 122, and 123 may respectively drive the red LED, the green LED, and the blue LED in accordance with the PWM signal.

Here, each of xR, yR, xG, yG, xB, and yB, which are the color coordinate values of the red LED, the green LED, and the blue LED, may be moved in accordance with an amount of the current flowing in the LED as described above, so that the control unit 110 may adjust xR, yR, xG, yG, xB, and yB, which are color coordinate values of the red LED, the green LED, and the blue LED, in accordance with the input brightness value.

The above-described adjustment of xR, yR, xG, yG, xB, and yB, which are the color coordinate values of the red LED, the green LED, and the blue LED, in accordance with the input brightness value may be performed based on a lookup table 111.

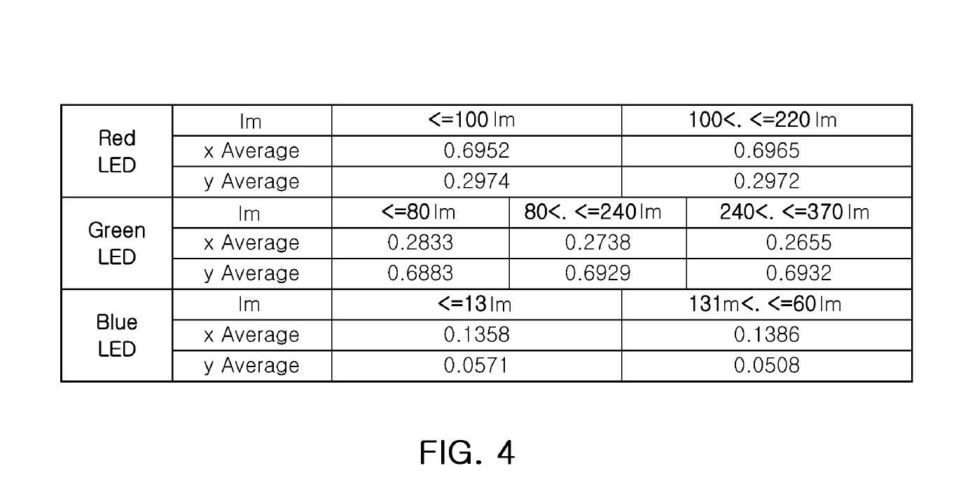

FIG. 4 is an example of a lookup table used in a driving apparatus for an LED according to an embodiment of the present invention.

Referring to FIGS. 3 and 4, in the lookup table 111, it may be seen that xR, yR, xG, yG, xB, and yB which are x-color coordinate values and y-color coordinate values of the red LED, the green LED, and the blue LED are individually adjusted in accordance with the respective brightness values of the red LED, the green LED, and the blue LED.

For example, when an input brightness value is equal to or greater than a preset reference brightness value, an x-color coordinate value of the red LED may be increased, and a y-color coordinate value of the red LED may be decreased.

That is, when the input brightness value is equal to or smaller than 100 lm, the x-color coordinate value of the red LED is 0.6952, however, when the input brightness value is 100 lm to 220 lm, the x-color coordinate value of the red LED may be adjusted to be 0.6965.

Similarly, when the input brightness value is equal to or smaller than 100 lm, the y-color coordinate value of the red LED is 0.2974, however, when the input brightness value is 100 lm to 220 lm, the y-color coordinate value of the red LED may be adjusted to be 0.2972.

In addition, for example, when the input brightness value is equal to or greater than the preset reference brightness value, an x-color coordinate value of the green LED may be decreased, and a y-color coordinate value of the green LED may be increased. When the input brightness value is equal to or greater than the preset reference brightness value, an x-color coordinate value of the blue LED may be increased, and a y-color coordinate value of the blue LED may be decreased.

That is, when the input brightness value is equal to or smaller than 80 lm, the x-color coordinate value of the green LED is 0.2833, however, when the input brightness value is 80 lm to 240 lm, the x-color coordinate value of the green LED may be adjusted to be 0.2738, and when the input brightness value is 240 lm to 370 lm, the x-color coordinate value of the green LED may be adjusted to be 0.2655.

In addition, when the input brightness value is equal to or smaller than 80 lm, the y-color coordinate value of the green LED is 0.6883. However, when the input brightness value is 80 lm to 240 lm, the y-color coordinate value of the green LED may be adjusted to be 0.6929, and when the input brightness value is 240 lm to 370 lm, the y-color coordinate value of the green LED may be adjusted to be 0.6932.

Similarly, when the input brightness value is equal to or smaller than 13 lm, the x-color coordinate value of the blue LED is 0.1358, and the y-color coordinate value thereof is 0.0571, however, when the input brightness value is 13 lm to 60 lm, the x-color coordinate value of the blue LED may be adjusted to be 0.1386, and the y-color coordinate value thereof may be adjusted to be 0.0508.

The above-described lookup table may be an example, and each of the x-color coordinate values and the y-color coordinate values of the red LED, the green LED, and the blue LED may be adjusted in accordance with the input brightness values with reference to the graph in which the color coordinates are moved in accordance with the current as shown in FIG. 2. In addition, in a section in which the color coordinate values are rapidly moved in accordance with the current, the lookup table may be set by adjusting a range of brightness values capable of adjusting the x-color coordinate values and the y-color coordinate values.

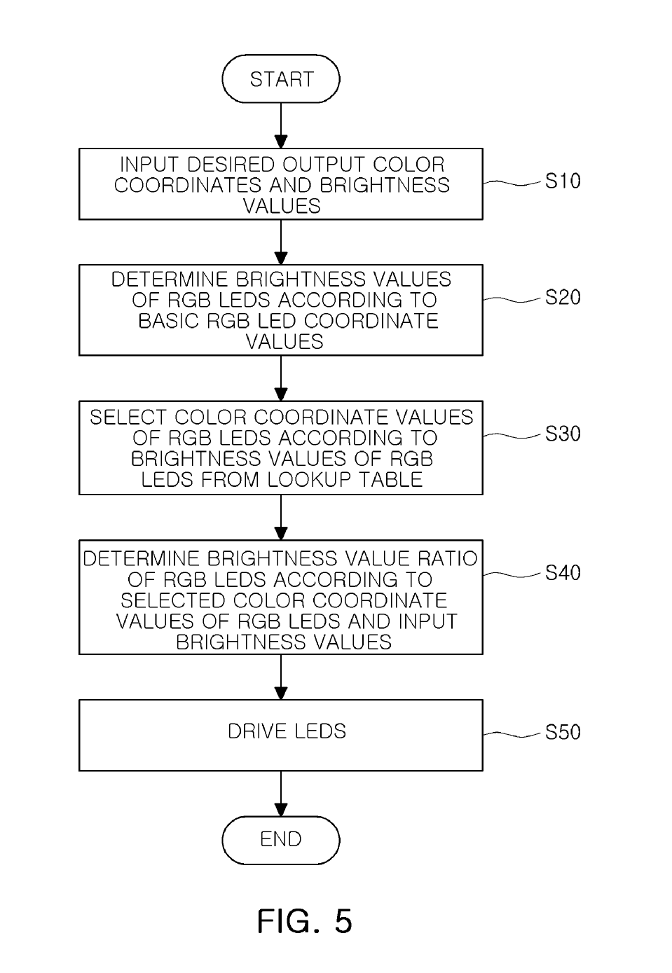

FIG. 5 is a flowchart illustrating a control method of a driving apparatus for an LED according to an embodiment of the present invention.

Referring to FIGS. 3 and 5, a control method of a driving apparatus for an LED according to an embodiment of the present invention will be described. First, in operations S10 and S20, the control unit 110 may receive a brightness value and a color coordinate value of an LED desired to be controlled, and determine a brightness value of each of a red LED, a green LED, and a blue LED.

In operation S30, an x-color coordinate value and a y-color coordinate value of each of the red LED, the green LED, and the blue LED may be selected from the lookup table 111 in accordance with the brightness value of each of the red LED, the green LED, and the blue LED.

In operation S40, the control unit 110 may determine a brightness value ratio of the red LED, the green LED, and the blue LED in accordance with the selected x-color and y-color coordinate values of each of the red LED, the green LED, and the blue LED, and the received brightness value. In operation S50, the first to third driving units 121, 122, and 123 may respectively drive the red LED, the green LED, and the blue LED in accordance with a PWM signal having the determined ratio.

As set forth above, with the use of a driving apparatus for an LED according to embodiments of the present invention, a desired color of light may be accurately displayed by adjusting color coordinate values in accordance with input brightness values.

In addition, a separate sensor or a feedback circuit is not adopted, thereby reducing a circuit area and manufacturing costs.

While the present invention has been shown and described in connection with the embodiments, it will be apparent to those skilled in the art that modifications and variations can be made without departing from the spirit and scope of the invention as defined by the appended claims.

What is claimed is:

1. A driving apparatus for alight emitting diode (LED), the driving apparatus comprising:
a control unit controlling LED driving by adjusting a color coordinate value in accordance with a brightness value of an LED desired to be controlled; and
a driving unit driving the LED in accordance with controlling of the control unit.

2. The driving apparatus of claim 1, wherein the driving unit includes:
a first driving unit driving a red LED in accordance with the controlling of the control unit;
a second driving unit driving a green LED in accordance with the controlling of the control unit; and
a third driving unit driving a blue LED in accordance with the controlling of the control unit.

3. The driving apparatus of claim 1, wherein the control unit includes a lookup table having color coordinate values set in accordance with the brightness value to thereby adjust the color coordinate value in accordance therewith.

4. The driving apparatus of claim 3, wherein the lookup table includes an x-color coordinate value and a y-color coordinate value of the red LED, an x-color coordinate value and a y-color coordinate value of the green LED, and an x-color coordinate value and a y-color coordinate value of the blue LED.

5. The driving apparatus of claim 4, wherein, when the brightness value is equal to or greater than a preset reference brightness value, the x-color coordinate value of the red LED is increased, and the y-color coordinate value of the red LED is decreased.

6. The driving apparatus of claim 4, wherein, when the brightness value is equal to or greater than a preset reference brightness value, the x-color coordinate value of the green LED is decreased, and the y-color coordinate value of the green LED is increased.

7. The driving apparatus of claim 4, wherein, when the brightness value is equal to or greater than a preset reference brightness value, the x-color coordinate value of the blue LED is increased, and the y-color coordinate value of the blue LED is decreased.

8. A control method of a driving apparatus for a light emitting diode (LED), the control method comprising:
receiving a brightness value and a color coordinate value of an LED desired to be controlled to thereby determine a brightness value of each of a red LED, a green LED, and a blue LED;
selecting, from a preset lookup table, an x-color coordinate value and a y-color coordinate value of each of the red LED, the green LED, and the blue LED in accordance with the brightness value of each of the red LED, the green LED, and the blue LED; and
determining a brightness value ratio of each of the red LED, the green LED, and the blue LED in accordance with the selected x-color coordinate value and y-color coordinate value of each of the red LED, the green LED, and the blue LED and the received brightness value.

9. The control method of claim 8, wherein, when the received brightness value is equal to or greater than a preset reference brightness value, the x-color coordinate value of the red LED is increased, and the y-color coordinate value of the red LED is decreased.

10. The control method of claim 8, wherein, when the received brightness value is equal to or greater than a preset reference brightness value, the x-color coordinate value of the green LED is decreased, and the y-color coordinate value of the green LED is increased.

11. The control method of claim 8, wherein, when the received brightness value is equal to or greater than a preset reference brightness value, the x-color coordinate value of the blue LED is increased, and the y-color coordinate value of the blue LED is decreased.
